(19) United States
(12) Patent Application Publication
(10) Pub. No.: US 2008/0259766 A1
(43) Pub. Date: Oct. 23, 2008

(54) Optical Pickup Actuator and Optical Scanning Device

(75) Inventors: Michael Adrianus Henricus Van Der Aa, Turnhout (BE); Peter Michael Silvester Maria Heijmans, Eindhoven (NL); Johannes Antonius Van Rooij, Eindhoven (NL); Jeroen Arnoldus Leonardus Johannes Raaymakers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/097,794

(22) PCT Filed: Dec. 13, 2006
(86) PCT No.: PCT/IB2006/054818

§ 371 Date: Jun. 17, 2008

(30) Foreign Application Priority Data
Dec. 21, 2005 (EP) 05112557.3

(51) Int. Cl. G11B 7/00

(52) U.S. Cl. 369/112.01

(57) ABSTRACT

An optical pickup actuator for low building height includes a suspended lensholder (101) with a lenssystem (102), focusing (106a, 106b, 106c 106d) and tracking coils (109) and magnets (107a, 107b, 107c) for cooperation with the focusing and tracking coils. The focusing and tracking coils may be arranged for tilting the lensholder in the actuator. The lowest entrance position for a radiation beam to enter a beam entrance (113) at a side of the actuator is not determined by the height and location of the coils.

### FIELD OF THE INVENTION

This invention relates to an optical pickup actuator comprising a lensholder having a lenssystem with an optical axis, the lensholder being suspended by a suspension means, a magnet system separated from said lensholder, a focusing coil system and a tracking coil system mounted to said lensholder, the lensholder having a beam entrance side substantially perpendicular to the optical axis for receiving a radiation beam.

The invention also relates to an optical scanning device comprising an optical pickup actuator.

### BACKGROUND OF THE INVENTION

Optical pickup actuators as well as optical read and/or write systems comprising an optical pickup actuator for scanning an optical record carrier such as a Compact Disc (CD) or Digital Versatile Disc (DVD) are known. For convenience an optical record carrier may in the following also be referred to as a disc, although also a card-shaped optical record carrier may be possible. Tracking and focusing coil systems on the lens holder cooperating with the magnet system on a fixed part of the optical pickup actuator allow the lensholder to be moved in a radial direction (tracking) and vertical direction (focusing). Optical read/and/or write systems comprising such an optical pickup actuator are known, for example, as CD and/or DVD data drives used in computers or DVD-recorders in video recording systems. In the following an optical read and/or write system such as, for example, a CD data drive, a DVD-recorder, etc. is referred to as an optical data drive. The trend to so-called slim-line or thin optical data drives for, for example, portable application such as notebook computers or slim-line videorecorder require slim-line or thin optical pickups or optical scanning devices for scanning the disc. The building height of the actuator, i.e. the total height of the actuator in the optical pickup in a plane perpendicular to the surface of the disc to be scanned, should thus be low.

The optical pickup thus also requires a slim-line or thin optical pickup actuator in order to limit the height of the optical scanning device. Such an optical pickup actuator is, for example, disclosed in US 2004/0103420. The optical pickup actuator comprises a focusing coil system having one focusing coil and a tracking coils system having four tracking coils mounted symmetrically to the lens holder cooperating with a magnet system of four magnets on a fixed part. This configuration is mentioned to be advantageous to reduce the moment generated at the focusing coils and the tracking coils such that the objective lens inclination can be small when the objective lens is displaced. US 2004/0103420 also discloses an embodiment in which the focusing coil system comprises two focusing coils and four tracking coils cooperating with a magnet system of four magnets. By having two focus coils arranged in a manner of being apart from each other allows for creation of a space within the side surface of the lensholder. This makes it possible to permit a radiation beam to pass from the side through the movable lens holder towards the objective lens. The configuration of the coils and magnets is chosen such that the objective lens inclination due to moment generated by the coil systems is small when the objective lens is displaced.

For some types of optical data drives, such as for scanning a DVD or Blu-ray Disc (BD), it is preferred that the optical axis of the objective lens is actively aligned to be perpendicular to the surface of the disc in order to compensate for disc tilt angle, i.e. active tilt adjustment of the objective lens in the optical pickup actuator to compensate e.g. coma introduced by tangential and/or radial disc tilt. Such active tilt-control allows for an improved read and/or write performance of the optical data drive. US 2004/0103420 is silent about the possibility for active tilt control.

In WO 03/102929 A2 an optical pickup actuator is disclosed adapted for active tilt control. The optical pickup actuator comprises a focusing coil and tracking coil system substantially extending in two parallel planes at a side of the lens holder. A magnet system is arranged separately from the lensholder. The focusing and tracing coil systems are arranged for effecting tilt through cooperation with the magnet system. However the arrangement of the coil systems does not allow for a slim line or thin actuator as the height and location of the coils determine lowest entrance position of for a radiation beam to enter the actuator.

### SUMMARY OF THE INVENTION

It is an object of the invention to provide an improved optical pickup actuator that is suitable for slim-line or thin optical scanning devices.

To this end there is provided an optical pickup actuator comprising a lensholder having a lenssystem for cooperation with a radiation beam, which lenssystem has an optical axis and which the lens holder is suspended by a suspension means, a magnet system separated from said lensholder, a focusing coil system, a tracking coil system which substantially extends in a first plane, which first plane is substantially parallel with respect to the optical axis, and the lensholder has a beam entrance side for receiving a radiation beam which has a direction substantially perpendicular to the optical axis, wherein the tracking coil system is located at the opposite of the beam entrance side on the other side of the optical axis.

Having the tracking coil system located opposite to the beam entrance side reduces the amount of coils and magnets at that side allowing room for a radiation beam to enter the optical pickup actuator.

The inventors became aware that the deletion of a tracking coil from one side of the lensholder would not change the resonance frequency of the lensholder in the frequency response function of the actuator, as these are internal lensholder resonance frequencies. In the low frequency domain, for example below 10 kHz, the lensholder may be considered as a rigid body. For high frequencies the lensholder may be considered as a assembly of local masses and stiff portions between them. During the design of the lensholder it is possible to apply stiff portions on specific locations in the lensholder, such that at dynamic excitation of the lensholder, the resonance modes preferably do not appear in the movement of the lens (or lensholder) or are preferably located at frequencies above the servo bandwidth of the system, such as for example, above 35 kHz for a BD notebook application.

Preferably, the tracking coil system comprises a single tracking coil.

This allows for a more space at the side of the lensholder on which the tracking coil system is located for other coil systems such as a focus coil system and/or a tilting coil system. This more space allows for larger coil systems for focusing and/or tilt that may either increase the efficiency for these coil systems and/or more accurately balanced actuated movement of the lensholder.

Preferably, the tracking coil system is mounted to the lensholder.

With the coil system mounted on the lensholder and not the corresponding magnet system mounted on the lensholder, the weight of the total mass to be actuated can be kept low. This is beneficial for power consumption and bandwidth of the actuator. To obtain a constant force over the total stroke of the actuator in focus, tracking or tilting direction it is preferred that the dimensions of the magnet/yoke is larger than the dimensions of the coil cooperating with that magnet. When the magnets are placed on the lensholder its dimensions will preferably be smaller than when placed on a non-moving portion of the actuator, because of required limitations to the moving mass of the lensholder in view of e.g. the mentioned power dissipation. To obtain again a constant force over the actuator stroke, the dimensions of the coils may be increased again, which leads to an inefficient use of the coil and increased dissipation. Preferably, also the focusing coil system is mounted on the lensholder for the same advantageous reasons.

Preferably, the magnetic system comprises two magnets at the beam entrance side allowing a radiation beam to enter the optical pickup actuator along a path between the two magnets.

The magnetic system of two magnets at the beam entrance side allows a radiation beam to enter the optical pickup actuator along a path between the two magnets. This avoids the radiation beam to enter below the magnet system, which would increase the effective height of the optical pickup actuator and thus the height of the optical scanning device.

In an embodiment according to the invention, the optical pickup actuator according the invention further has a focusing coil system substantially extending in the first plane in which the tracking coil system is located and also a second plane that located opposite to the first plane on the other side of the optical axis.

This allows for a possibility to have a focusing coil system on both sides of the lensholder, which increases the efficiency and thus performance of the focus actuation of the focus servo system in the optical data drive. Also the angle accuracy of the movement of the lensholder is improved.

Preferably, the optical pickup actuator, further has a focusing coil system with one or more pairs of coils each at opposite side of the lensholder, wherein the pair or pairs of coils forms or form a means for tilting the lensholder.

When the focusing coil system comprises at least one pair of coils each at opposite side of the lensholder, wherein the pair or pair of coils forms a means for tilting the lensholder, it is not required to have a separate coil system for tilting the lensholder. This reduces the complexity of the actuator and avoids additional mass to be actuated.

In another embodiment according to the invention, the optical pickup actuator has a focusing coil system comprises one coil arranged in a plane substantially perpendicular to the optical axis.

Preferably, the one coil is around a top portion of the lensholder.

The location at the top of the lensholder (located at the side of the disc to be scanned) brings the moment applied on the lensholder during focus actuation closer to the center of gravity of the lensholder. This reduces the amount of tilt of the lensholder during focus actuation. When the tracking coil is also reduced in height a low building height of the actuator is obtained.

A focusing coil system comprising of a single coil located at the top of the lensholder allows for a space at both sides of the lens holder for additional coil systems required for tilt control according to another preference in which, one or more pairs of coils are located at each opposite side of the lensholder, wherein the pair or pairs of coils forms or form a means for tilting the lensholder.

The focus coil at the top of the lensholder and the single tracking coils allow for the use of one or more pairs of coils for tilting. With a single pair of coils a possibility for e.g. a radial or tangential tilt is made possible.

In a preferred embodiment, two pairs of coils are applied making it possible to tilt the lensholder in two different directions, e.g. a radial tilt and a tangential tilt. In this way coma due to disc tilt can be compensated in two directions, which improves the scanning performance of the optical scanning device.

In an other embodiment according to the invention, the optical scanning device is further comprising a second lenssystem for cooperation with a second radiation beam, the second lenssystem having a second optical axis, the lens holder having a second beam entrance side for receiving the second radiation beam, the second beam entrance side being substantially perpendicular to the first plane in which the tracking coil system is located.

Application of a second lenssystem makes it possible to adapt the optical pickup actuator for scanning a second, third or even fourth type of optical record carrier. The lenssystem may for example be designed for scanning a CD and/or DVD and the second lenssystem may be designed for scanning a BD. Also other combinations are possible such as, for example, the lenssystem being designed for scanning a CD and/or HDDVD and the second lenssystem being designed for scanning a DVD and/or BD, or vice versa.

The invention further relates to an optical scanning device in which an optical pickup actuator is according to the invention is provided, particularly an optical scanning device having a small height.

With reference to the claims, it is noted that various characteristic features as defined in the set of claims may occur in combination.

The above mentioned an other aspects of the invention are apparent from and will be elucidated, by way of non-limiting examples, with references to the embodiments described hereafter.

### BRIEF DESCRIPTION OF THE DRAWINGS

The features and advantages of the various embodiments of the invention will become apparent from the following description, given by way of example only, of preferred embodiments of the invention, which refers to the accompanying drawings, wherein:

FIG. 1, comprising FIGS. 1A, 1B and 1C, schematic shows views of an optical pickup actuator according to the invention, in which FIG. 1A shows a top view, FIG. 1B shows a sectional view taken on the line I-I′ in FIG. 1A, and FIG. 1C shows a side view.

FIG. 2, comprising FIGS. 2A, 2B and 2C, schematically shows top (FIG. 2A) and side views of lensholder (FIG. 2B and FIG. 2C), coil systems and magnet systems according to an embodiment of the invention.

FIG. 3, comprising FIGS. 3A, 3B and 3C schematically shows top (FIG. 3A) and side views of lensholder (FIG. 3B and FIG. 3C), coil systems and magnet systems according to another embodiment of the invention.

FIG. 4 schematically shows a part of the optical scanning actuator in a further embodiment according to the invention.

FIGS. 5A and 5B schematically showing the possible beam entrance angles for the optical pickup actuators according to the invention.

FIG. 6 schematically shows the layout of an optical scanning device using the optical pickup actuator according to the invention.

### DETAILED DESCRIPTION OF THE PREFERRED EMBODIMENTS

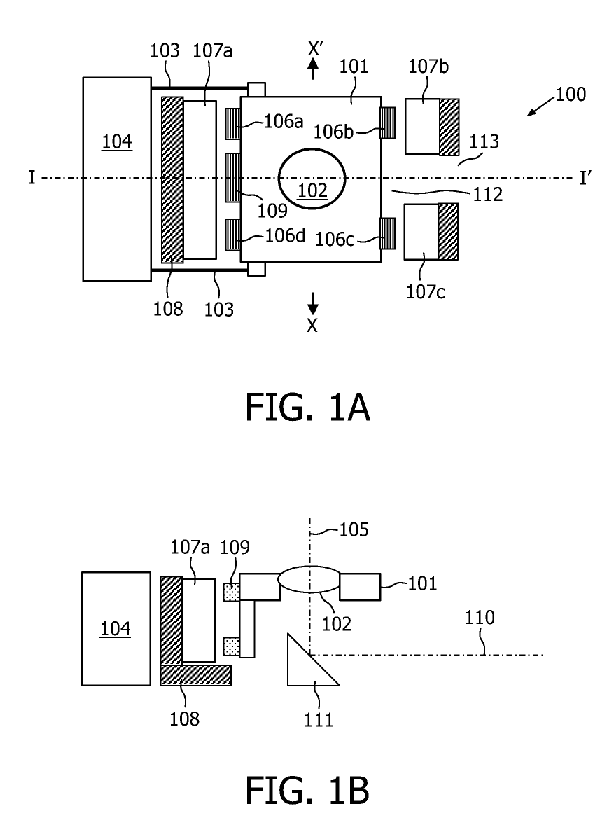

FIG. 1 schematically shows various views of an optical pickup actuator 100 according to the invention. The optical pickup actuator 100 will in the following for convenience be referred to as ‘actuator’. With reference to FIGS. 1A, 1B and 1C, a lens holder 101 having a lenssystem 102, is suspended from a connecting block 104 by a suspension means 103. This suspension means may, for example, comprise of suspension beams such as metal elastic rods. In FIGS. 1A, 1B and 1C the suspension means are shown as four metal elastic rods 103 that extend transversely to the optical axis 105 of the lenssystem (see FIG. 1B). The lenssystem 102 may be, for example, a single element objective lens or a multi-element objective lens.

One side of each elastic rod is fixed to the lensholder and the other side of the elastic rod is fixed to the connection block. It is noted that FIG. 1A and FIG. 1C only shows two of the four elastic rods 103. The use of the four elastic rods 103 enables the lens holder 101 to be moved with respect to the connecting block 104, thereby elastically deforming the elastic rods 103, over small distances in directions parallel to the optical axis 105 of the lenssystem and perpendicular to the optical axis 105 in the two opposite directions X and X′. These X and X′ direction may coincide in the application of the actuator, such as for example in a DVD data drive, with the two opposite radial direction of the optical record carrier (i.e. perpendicular to the track).

Alternatively the suspension is being achieved by means of plastic hinges providing the same function as the metal elastic rods. The cross-section shape of the rod can be circular, elliptical, square or any other suitable or specific shape.

The lenssystem 102 may be an objective lens comprising only a single lens or a multiple of lenses. The lenssystem may be designed for scanning a single type of optical record carrier, such as for example a CD or a DVD, but may also be designed for scanning multiple types of optical record carriers, such as for example CD and DVD, or DVD and BD, or BD and CD.

A focusing coil system of four coils 106a, 106b, 106c and 106d, i.e. driving coils is mounted on the lensholder 101. Permanent magnets 107a, 107b, 107c are mounted onto and fixed to portions of closing yoke 108 to cooperate with the focusing coil system.

In operation all, a Lorentz-force is generated by interaction between the magnetic field of a permanent magnet and an electric current in the coil (e.g. a focus coil or a tracking coil), under which Lorentz-force the lens holder is displaced in a direction determined according to commonly known interactions between the magnetic field direction, coil orientation and current direction in the coil.

Alternatively the focusing coil system only comprises two focusing coils instead of four. The number of cooperating corresponding permanent magnets (or magnet portions) will then reduce accordingly.

A tracking coil system 109 is mounted on a single side of the lensholder 101 extending in a plane substantially parallel to the optical axis 105. This plane is located opposite of the beam entrance side of the lens holder 112. The tracking coil system 109 shown in FIG. 1A comprises a single tracking coil and is cooperating with permanent magnet 107a. The permanent magnet 107a has multiple magnetization portions and will be discussed later.

Alternatively the tracking coil system 109 comprises two tracking coils located at the same side of the lensholder. Both focusing coils 106a and 106d as well as these two tracing coils may use the single permanent magnet 107a with several magnetization portions. It is also possible that two separate permanent magnets with another pattern of magnetization portions is used to cooperate with the focusing and tracking coils. Each separate permanent magnet may then be cooperating with, for example, a single tracking coil and focusing coil, or with only the two focusing coils or the two tracking coils.

The metal elastic rods 103 may also be used as part of the interconnection between the coils and the driver electronics (not shown) for driving the optical pickup actuator. The rods are then preferably electrical conductive. Separate leads to the movable lensholder 101 with the coils may then not be required, which may be advantageous for the dynamical behavior of the optical pickup actuator as well as for the assembly and cost.

Although only four metal elastic rods are shown in FIG. 1A in combination with FIG. 1C it may be preferred to have a suspension means comprising of six metal elastic rods that can act as part of the electrical interconnect with the coils. If no separate connections for the three coil-sets (109, 106a and 106b, 106c and 106d) are required, for example when using common junction geometry, four metal elastic rods may suffice. However, this may result in a complex drive circuit as well as electrical crosstalk. Preferably, when separate connections for the three coil-sets (109, 106a and 106b, 106c and 106d) are required six metal elastic rods are applied.

The coils, e.g. tracking or focusing coils, can be manufactured according to well-known techniques such as a wire winding process, a flat coil patterning process, or alike. The mounting and fixation to the lensholder can also be done according to known techniques.

It may also be possible to mount the permanent magnets onto the movable lensholder and the coils on the non-movable part of the actuator, although this may require some more space on the lensholder than in the situation the coils are mounted on the lensholder.

As shown in FIG. 1A a beam entrance 113 of the optical pickup actuator is located at the beam entrance side 112 of the lensholder that is available opposite to the tracking coil system (or vice versa). In the focusing coil system as shown in FIG. 1A a radiation beam (that is to be generated in the optical scanning device incorporating the actuator) can enter the actuator along an optical path 110 between the yoke-magnet-coil combinations 108-107c-106c and 108-107b-106b. The radiation beam may enter the beam entrance at an angle. By means of a reflective optical component 111 such as, for example, a folding prism the radiation beam entering the actuator can be directed towards the lenssystem 102 in the lensholder 101 for focusing on the optical record carrier to be scanned (not shown).

It can be seen that in this example the focus coil system is located in two planes: a first plane in which the tracking coil system is located as well as in another, second plane parallel to the first plane at the other side of the optical axis 105.

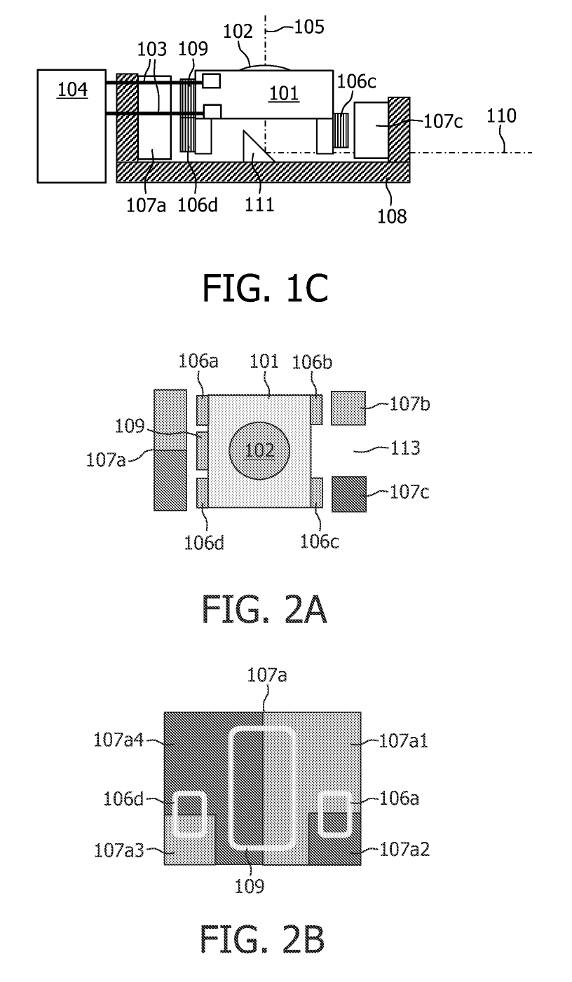

Referring to FIG. 2, show top (FIG. 2A) and side views (FIGS. 2b and 2C) for the magnet-coil layout in relation to the lensholder 101 and the beam entrance 113. FIG. 2A shows a schematic top-view; FIG. 2B shows a schematic view from lenssystem towards the connecting block and FIG. 2C shows a schematic view from lenssystem towards the beam entrance side. Permanent magnet 107a is cooperating with focusing coils 106a and 106d as well as with tracking coil 109. The permanent magnet 107a has in this embodiment four magnetization zones, for example, such as indicated in FIG. 2B. Depending on the requirements of the actuator the amount and layout of the zones may be different. Each coil cooperates with an N pole and an S pole.

Preferably the magnetization of the magnets is perpendicular to the surface of the magnet, as a magnetization at an angle may introduce crosstalk from radial to focus direction and vice versa.

When the magnet pole layout for each focusing coil is the same, for example when all N-poles are located at the top of the actuator, the four coils can be used for focusing the lens in the lensholder onto an information layer of an optical recording carrier to be scanned. In FIGS. 2A, 2B and 2C the magnet pole layout of magnets 107a, 107b and 107c are such that the focusing coils 106a and 106b cooperate with a same magnet pole layout (e.g. N-pole at the top side) and that focusing coils 106c and 106d cooperate with a magnet pole layout that is mirrored, e.g. S-pole at the top side). Coil 106a is cooperating with magnetization portions 107a1 and 107a2, while coil 106d is cooperating with magnetization portions 107a3 and 107a4. Portions 107a1 and 107a3 can be N-poles and portions 107a2 and 107a4 can then be S-poles. Coil 106b is cooperating with the two poles 107b1 and 107b2 of magnet 107b and coil 106c is cooperating with the two poles 107c1 and 107c2 of magnet 107c. When coil 106a is series connected with coil 106b and named ‘Foc1’, and coil 106c series connected with coil 106d and named Foc2, the focus and tilt functionality is combined (integrated). By applying a same driving current thought Foc1 and Foc2 the lensholder the resulting force is in the direction of the optical axis of the lens (i.e. focus-direction). When opposite driving currents are applied through Foc1 and Foc2, the resulting forces for each set of coils directs in the opposite focus-direction and thus resulting in a tilt of the lensholder. A triple output actuator driver may be sufficient for driving the tracking coil and Foc1 and Foc2, making it possible to apply movements of the lensholder in the focus direction, tracking direction as well as a radial tilt (along an axis perpendicular to the X-X′ axis). In this way, while scanning an optical recording medium with a radiation beam, the coma introduced in the scanning beam due to a disc tilt in radial direction may be compensated by a tilt of the objective lens in the radial direction.

The tracking coil 109 can also cooperate with permanent magnet 107a for the tracking movement to be made with the actuator. For example, as shown in FIG. 2B, the tracking coil cooperates with two magnetization portions (poles) 107a1 and 107a4 in the permanent magnet 107a.

Other combinations can be designed leading to the same possibility for focusing and tracking movements of the actuator, or focusing, tracking and tilting movements of the actuator.

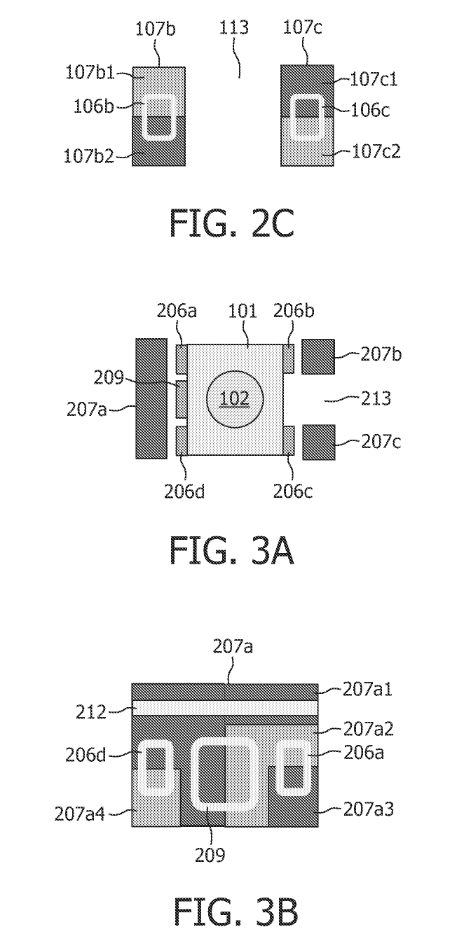

Reference is made to FIG. 3 comprising FIGS. 3A, 3B and 3C on another embodiment according to the invention.

FIG. 3A shows a schematic top-view; FIG. 3B shows a schematic view from the lenssystem towards the connecting block and FIG. 3C shows a schematic view from the lenssystem towards the beam entrance side. The lensholder 101 with the lenssystem 102 comprises a single focusing coil 212 mounted to lensholder 101. Preferably the focusing coil 212 is mounted around top of the lensholder, such that when an electrical current is directed thought the focusing coil the applied momentum to the combination of lensholder with the lenssystem is closely to the center of gravity of that combination. The focusing coil is preferably orientated perpendicular to the optical axis of the lenssystem. In this way, when actuated, there will only be a movement of the lensholder pin a direction parallel to the optical axis. The focusing coil 212 is cooperating with three permanent magnets 207a, 207b and 207c. As the direction of the resulting movement is preferably perpendicular to the plane of the focusing coil the magnet portions 207a1, 207b1 and 207c1 at the topside of the actuator cooperating with the focusing coil are preferably the same poles (for example, N-poles). Note that the focusing coil 212 is not shown in FIG. 3A in order to show coils 206a, 206b, 206c, 206d and 209, but is shown in FIGS. 3B and 3C. The beam entrance side 213 is located between the magnets 207b and 207c in a direction substantially perpendicular to the optical axis and with the tracking coil system located at the opposite of the beam entrance side.

The tracking coil system comprises of a single tracking coil 209 cooperating with magnetization portions 207a1 and 207a2 of permanent magnet 207a. Having different magnetizations the portions 207a1 and 207a2 create a magnetic field at the tracking coil such that when an electrical current is applied to the tracking coil 209, the Lorentz-force is directed in the plane of the coils. Depending on the direction of the electrical current through the tracking coil the Lorentz-force is directed in the X or in the X′ direction.

Although displacements of the lensholder in both the focusing and tracking direction can now be made if the appropriate currents are applied to the respective coil systems 212 and 209, additional coils can be added for tilting movements of the lensholder. In this embodiment four additional coils 206a, 206b, 206c and 206d are added cooperating with respectively permanent magnets 207a, 207b, 207c and 207a. The resulting are preferably along a first axis parallel to the I-I′ direction and along a second axis parallel to the X-X′ direction. The tilt along the first axis can be used, for example, for introducing a lenssystem to tilt compensate the coma in the scanning spot due to for example a radial tilt of the disc. The tilt along the second axis can be used, for example, for introducing a lenssystem tilt to compensate the coma in the scanning spot due to for example a tangential tilt of the disc.

As coil 206b cooperates with two magnetization portions 207b2 and 207b3 having different polarity, the permanent magnet 207b in this example has three magnetization portions 207b1, 207b2 and 207b3 (in this example respectively an S-pole, N-pole and S-pole). Similar, coil 206a also has to cooperate with two magnetization portions. This requires in this example that the permanent magnet 207a has at the side of the coil 206a also three magnetization portions 207a1, 207a2 and 207a3 (in this example an S-pole, N-pole and S-pole). Both magnetization portions 207a1 and 207b1 cooperate with the focusing coil 212 and preferably not with the coils 206a and 206b as this may introduce cross talk in the characteristics between the applied current and the lensholder tilt.

Coils 206c and 206d respectively cooperate with magnets 207c and 207a. Magnet 207c has two magnetization portions 207c1 and 207c2, in this example respectively an S-pole and an N-pole. Portion 207c1 also cooperates with the focusing coil 209. Magnet 207a has two magnetization portions 207a1 and 207a4 (in this example respectively an S-pole and an N-pole) for cooperation with coil 206d.

Depending on the winding directions and/or interconnections between the coils 206a, 206b, 206c and 206d it is possible to generate an effective momentum to the lensholder that leads to a tilt along an axis parallel to the I-I′ axis, so, for example a tilt in the radial direction. It is also possible that magnet 207b is magnetized as magnet 207c in which case the winding direction of coil 206b must be the opposite of coil 206c.

The choice for winding directions and/or interconnections between the coils (e.g. parallel-arranged or series-arranged coils) can be decided upon by the skilled person having knowledge on actuators and specifically on optical pickup actuators.

Use of only a tracking coil system opposite to the beam entrance may have some effect on the yaw-mode in the actuator system, such as described in the previous embodiments. A yaw-mode may become visible in the frequency response function of the actuator when the effective position of the applied forces (as generated by the currents trough the coils in the presence of the magnetic fields by the magnets) does not coincide with the position of the center of gravity of the lensholder and also preferably with the movement of the optical axis. In the lensholder design adapting the position of the total center of gravity of the lensholder with respect to this excitation position and movement may compensate this for this effect. In that situation the amplitude and phase in the frequency response function may be kept at an acceptable low level.

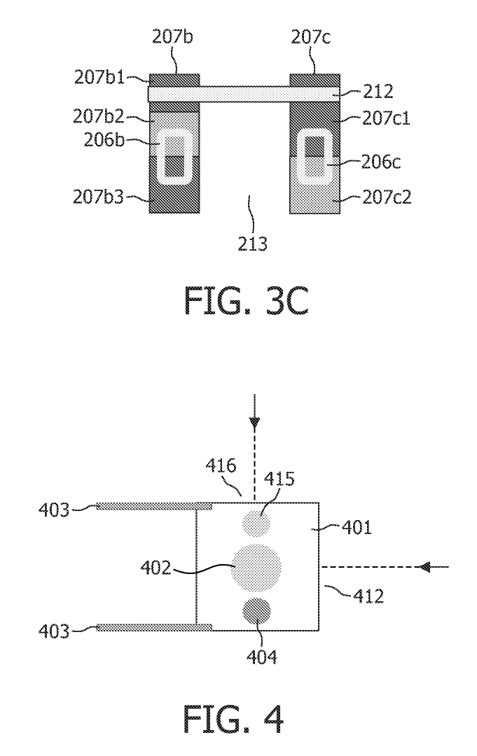

The invention can also be applied to an optical pickup actuator in which two lenssystems are used. An example is schematically shown in FIG. 4, in which a lensholder 401 comprises a first lenssystem 402 and a second lenssystem 415. Both lens systems may be arranged in a radial direction as shown in FIG. 4 or in a tangential direction. The first lenssystem may for example be a CD/DVD compatible objective lens as, for example, current applied in DVD data drives. The coil-magnet layout of the actuator may for example be one of the above-described embodiments, in which the first radiation beam can enter the actuator at the beam entrance side 412 as described. The second lenssystem 415 may, for example, be a BD objective lens for cooperation with a second radiation beam. The second lenssystem has a second optical axis and the lensholder 401 has a second beam entrance side 416 for receiving the second radiation beam. The second beam entrance side 416 is located substantially perpendicular to the plane defined by the tracking coil system. A reflective optical element (not shown) can reflect the second radiation beam that entered the second beam entrance towards the second lenssystem 415. In order not to generate obscurations by the suspension means 403, for example flexible metal rods, connecting the lensholder to the connection block (not shown) are attached to the edge of the lensholder.

An extra element 404 may be added to the lensholder, for example for the purpose of mass balance. This extra element may be a balancing mass for balancing the mass difference between both lenssystems. It may also be a bumper protecting the lens and disc when the lensholder is contacting the disc. It may also be an additional optical element such as a lenssystem.

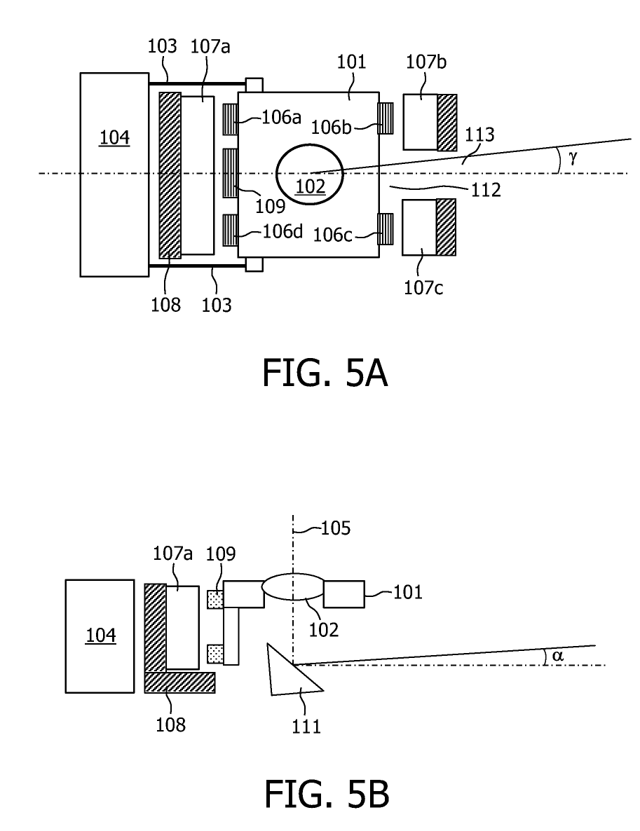

Referring now to FIG. 5A, the radiation beam may enter the beam entrance 113 of the optical pickup actuator at an angle γ of about 90 degrees with the optical axis of the lenssystem 102 in the lensholder 101. However, preferably the angle is less than 90 degrees in order to further reduce the building height of the optical pickup.

Referring to FIG. 5B, in another direction the radiation beam may enter the beam entrance 113 of the optical pickup actuator at an entrance angle α between 45 and 135 degrees with the tracking coil system that is extending in a first plane substantially parallel with respect to the optical axis of the lenssystem 102. Preferably, the entrance angle is between 70 and 110 degrees. More preferably, the entrance angle is substantially 90 degrees.

With the above embodiments it is possible to provide an optical pickup actuator for slim-line or thin optical scanning devices which actuator allows for active tilt-control.

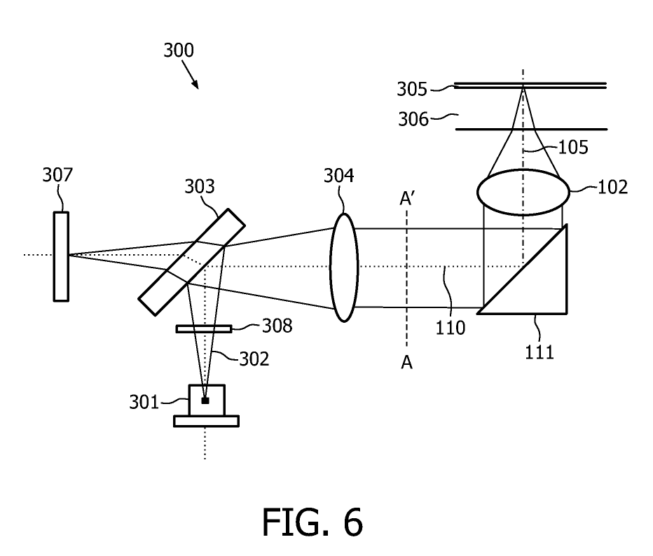

The above-described embodiments of the optical pickup actuator can be applied to an optical scanning device such as, for example, schematically shown in FIG. 6. It is considered to advantageous for the building height of the total optical scanning device to make use of the optical pickup actuator according to the embodiments of the invention. A brief description of such an optical pickup device is given below. For more general information on optical pickup (or scanning) devices and optical storage technology reference is made to general available literature on the subject, such as the book by G. Bouwhuis, J. Braat, A. Huijser et al, “Principles of Optical Disc Systems”, (Adam Hilger 1985, ISBN 0-85274-785-3).

In FIG. 6 a schematic view of an example of an optical scanning device 300 is presented. A radiation source 301, such as a semiconductor laser, is provided for emitting a radiation beam 302. This radiation beam is reflected by a beamsplitter 303 along an optical path 110 towards a collimator lens 304. The collimator lens transforms the divergent radiation beam 302 into a substantially parallel radiation beam. The radiation beam then enters the beam entrance of an optical pickup actuator according to the invention and is reflected by a mirror 111 towards the objective lens 102 that is mounted in the lensholder 101 of an optical pickup actuator according to the invention. The objective lens 102 focuses the radiation beam onto an information layer 305 of an optical record carrier 306 to be scanned. After reflection by the information layer, the radiation beam is transmitted by the objective lens 102 and mirror 111 towards the collimator lens 304. The collimator lens is focusing the radiation beam via transmission of the beamsplitter 303 towards the photodetector 307. The photodetector 207 is adapted for focusing error and tracking error signal generation by making use in the optical scanning device of, for example, the astigmatic focusing method and push-pull tracking method. When a three beam tracking method is used, such as the three beam push-pull tracking methods, a diffraction grating 308 is located in the radiation beam towards the record carrier.

It should be noted that the optical layout of the optical scanning device 300 is drawn in a two-dimensional plane. In order to have a slim-line or low building height optical scanning device the elements on the left-hand side of the line A-A′, are preferably orientated differently; that part of the optical layout is then to be rotated along line of the optical path 110, for example 90 degrees, such that the radiation source 301 is located out of the figure. The line A-A′ may be interpreted to be located at the beam entrance 113 or 213 of the optical pickup actuator. As already described above in reference to FIGS. 5A and 5B, the angle of the radiation beam towards the optical pickup actuator may be different than perpendicular to the optical axis 105 of the lenssystem 102.

The focus and tracking error signals generated via the photodetector 307 and the servo-electronic circuitry (not shown) are used for controlling the movements of the lenssystem 102 in the lensholder of the optical pickup actuator in the focus and tracking directions. The photodetector 307 may also be adapted to generate one or more tilt error signals for controlling the radial and tangential tilt of the objective lens in the optical pickup actuator. Additional electronic circuitry for processing such tilt error signals may be added to the optical pickup device. Alternatively a separate detection system, such as for example a tilt sensor, may be used for creating the tilt error signal or signals.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An optical pickup actuator (100) comprising:
a lensholder (101, 401) having a lenssystem (102, 402) for cooperation with a radiation beam, which lenssystem has an optical axis (105) and which the lens holder is suspended by a suspension means (103),
a magnet system (107a, 107b, 107c; 207a, 207b, 207c) separated from said lensholder,
a focusing coil system (106a, 106b, 106c, 106d, 212),
a tracking coil system (109, 209) which substantially extends in a first plane, which first plane is substantially parallel with respect to the optical axis, and
the lensholder has a beam entrance side (112, 412) for receiving a radiation beam which has a direction substantially perpendicular to the optical axis,
characterized in that the tracking coil system is located at the opposite of the beam entrance side on the other side of the optical axis.

2. The optical pickup actuator as claimed in claim 1, wherein the tracking coil system comprises a single tracking coil (109, 209).

3. The optical pickup actuator as claimed in claim 1, wherein the tracking coil system is mounted to the lensholder.

4. The optical pickup actuator as claimed in claim 1 wherein in that the magnetic system comprises two magnets (107b, 107c; 207b, 207c) at the beam entrance side allowing a radiation beam to enter the optical pickup actuator along a path (110) between the two magnets.

5. The optical pickup actuator as claimed in claim 1, wherein the focusing coil system (106a, 106b, 106c, 106d) substantially extends in the first plane and a second plane that is located opposite to the first plane on the other side of the optical axis.

6. The optical pickup actuator as claimed in claim 5, wherein the focusing coil system comprises one or more pairs of coils (106a, 106b, 106c, 106d) each at opposite side of the lensholder, wherein the pair or pairs of coils forms or form a means for tilting the lensholder.

7. The optical pickup actuator as claimed in claim 6, wherein the means for tilting the lensholder is adapted to tilt the lensholder around an axis substantially perpendicular to the first plane in which the tracking coil system is extending.

8. The optical pickup actuator as claimed in claim 1, wherein the focusing coil system (212) comprises one coil arranged in a plane substantially perpendicular to the optical axis.

9. The optical pickup actuator as claimed in claim 8, wherein the one coil is around a top portion of the lensholder.

10. The optical pickup actuator as claimed in claim 8, comprising at least one pair of coils at each opposite side of the lensholder, wherein the at least one pair of coils forms a means for tilting the lensholder.

11. An optical pickup actuator as claimed in claim 10, the means for tilting the lensholder is adapted to tilt the lensholder around a first axis substantially perpendicular to the first plane in which the tracking coil system is extends.

12. An optical pickup actuator as claimed in claim 11, wherein the means for tilting the lensholder is further adapted to tilt the lensholder around a second axis substantially parallel to the first plane in which the tracking coil system extends and substantially perpendicular to the optical axis.

13. An optical pickup actuator according to claim 1, wherein a second lenssystem (415) is comprised for cooperation with a second radiation beam, the lensholder having a second beam entrance side (416) for receiving the second radiation beam, which second beam entrance side is substantially perpendicular to the first plane in which the tracking coil system is located.

14. An optical scanning device (300) comprising an optical pickup actuator according to claim 1.

15. An optical scanning device (300) comprising an optical pickup actuator according to claim 5.

16. An optical scanning device (300) comprising an optical pickup actuator according to claim 8.

17. An optical scanning device (300) comprising an optical pickup actuator according to claim 13.
